(19) United States
(12) Patent Application Publication
(10) Pub. No.: US 2026/0124646 A1
(43) Pub. Date: May 7, 2026

(54) STONE CLEANER AND SEMICONDUCTOR FABRICATING APPARATUS COMPRISING THE SAME

(71) Applicant: Samsung Electronics Co., Ltd., Suwon-si (KR)

(72) Inventors: Dong Hyun KIM, Suwon-si (KR); Won Bae JO, Suwon-si (KR); Sun Ho KIM, Suwon-si (KR); Chang Ju YUN, Suwon-si (KR); Yong Joo CHO, Suwon-si (KR)

(21) Appl. No.: 19/375,400

(22) Filed: Oct. 31, 2025

(30) Foreign Application Priority Data
Nov. 4, 2024 (KR) 10-2024-0154205

(51) Int. Cl. B08B 1/10; B08B 1/40; B08B 13/00

(52) U.S. Cl. CPC B08B 1/10; B08B 1/40; B08B 13/00

(57) ABSTRACT

There is provided a stone cleaner includes a main body including a guide recess; a handle configured to move up and down along the guide recess; and a cleaning unit installed on a lower surface of the main body, including a cleaning stone, wherein a plurality of guide pins are installed in the guide recess of the main body, and an elastic body is installed in at least one of the plurality of guide pins, a plurality of guide holes corresponding to the plurality of guide pins are installed in the handle, when the handle is pressed downward, the guide pin is inserted along an extension direction of the guide hole, and the elastic body is compressed so that a repulsive force of the elastic body adjusts a pressing force of the handle.

### CROSS-REFERENCE TO RELATED APPLICATION

This application claims priority under 35 U.S.C. § 119 from Korean Patent Application No. 10-2024-0154205, filed Nov. 4, 2025, in the Korean Intellectual Property Office, and all the benefits accruing therefrom under 35 U.S.C. 119, the contents of which in its entirety are herein incorporated by reference.

### BACKGROUND

### Technical Field

The present disclosure relates to a stone cleaner and a semiconductor fabricating apparatus comprising the same.

### Description of the Related Art

An exposure device projects a mask pattern (i.e., design layout) onto a sensitive material (i.e., resist) formed on a wafer. For the exposure of fine patterns, the exposure device may adopt, for example, a Deep Ultra-Violet (DUV) light source. In this case, in order to stably fix a wafer, the wafer may be fixed onto a wafer table in a vacuum manner. On the wafer table, a plurality of burls are installed to be spaced apart from each other at predetermined intervals, and a height of each burl may be tens to hundreds of um. Heights of the plurality of burls are managed in accordance with a predetermined specification (i.e., flatness management). In this case, warpage of the wafer may be prevented, and defocus is not generated in an exposure process.

Meanwhile, while the exposure process is being performed, the wafer table is exposed to various kinds of chemical/physical stresses, and deposits may be accumulated on the burls. These deposits inhibit the flatness.

### SUMMARY

An object of the present disclosure is to provide a stone cleaner capable of stably cleaning a wafer table.

Another object of the present disclosure is to provide a semiconductor fabricating apparatus comprising a stone cleaner capable of stably cleaning a wafer table.

The objects of the present disclosure are not limited to those mentioned above and additional objects of the present disclosure, which are not mentioned herein, will be clearly understood by those skilled in the art from the following description of the present disclosure.

According to an aspect of the present disclosure, there is provided a stone cleaner comprises a main body including a guide recess; a handle configured to move up and down along the guide recess; and a cleaning unit installed on a lower surface of the main body, and including a cleaning stone, wherein a plurality of guide pins are installed in the guide recess of the main body, and an elastic body is installed in at least one of the plurality of guide pins, a plurality of guide holes corresponding to the plurality of guide pins are installed in the handle, when the handle is pressed downward, the guide pin is inserted along an extension direction of the guide hole, and the elastic body is compressed so that a repulsive force of the elastic body adjusts a pressing force of the handle.

According to another aspect of the present disclosure, there is provided a stone cleaner comprising a main body including a guide recess, a handle configured to move up and down along the guide recess, including a knob for a worker to grasp with a finger, and a cleaning unit installed on a lower surface of the main body, and including a cleaning stone, wherein the main body includes an outer wall and an inner wall, which define the guide recess, a plurality of guide pins are installed in the guide recess of the main body, the plurality of guide pins are more protruded upward than the inner wall, and a coil spring is installed in at least one of the plurality of guide pins, a plurality of guide holes corresponding to the plurality of guide pins are installed in the handle, the plurality of guide holes include a first guide hole and a second guide hole, the first guide hole passes through the handle without overlapping the knob, the second guide hole overlaps the knob, and the plurality of guide pins include a first guide pin corresponding to the first guide hole and a second guide pin corresponding to the second guide hole, when the handle is pressed downward by a predetermined depth or more, the first guide pin completely passes through the first guide hole so that a tip of the first guide pin is exposed to the outside of the handle.

According to an aspect of the present disclosure, there is provided a semiconductor manufacturing device comprising a wafer table provided with a plurality of burls formed on a surface, a stone cleaner configured to clean the wafer table, and a controller controlling the stone cleaner, wherein the stone cleaner includes a main body including a guide recess, a handle configured to move up and down along the guide recess, and a cleaning unit installed on a lower surface of the main body, including a cleaning stone, a plurality of guide pins are installed in the guide recess of the main body, and an elastic body is installed in at least one of the plurality of guide pins, a plurality of guide holes corresponding to the plurality of guide pins are installed in the handle, and when the handle is pressed downward, the guide pin is inserted along an extension direction of the guide hole, and the elastic body is compressed so that a repulsive force of the elastic body adjusts a pressing force of the handle.

Details of the other embodiments are included in the detailed description and drawings.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a perspective view illustrating a stone cleaner according to some example embodiments of the present disclosure;

FIG. 2 is a perspective view illustrating a stone cleaner of FIG. 1, which is viewed from below;

FIG. 3 is an exploded perspective view illustrating a stone cleaner of FIG. 1;

FIG. 4 is a perspective view illustrating arrangement of a guide pin and an elastic body in the stone cleaner of FIG. 1;

FIG. 5 is a view illustrating that the stone cleaner of FIG. 4 is viewed from B;

FIG. 6 is a cross-sectional view taken along line A-A of FIG. 5;

FIG. 7 is a view illustrating an operation of a stone cleaner of FIG. 1;

FIGS. 8 and 9 are views illustrating a cleaning unit of the stone cleaner of FIG. 1;

FIG. 10 is a view illustrating a ring guard of the stone cleaner of FIG. 1;

FIGS. 11 and 12 are views illustrating a method for disassembling a stone cleaner according to some example embodiments of the present disclosure;

FIG. 13 is a view illustrating a stone cleaner according to some example embodiments of the present disclosure;

FIG. 14 is a plan view illustrating a plurality of pressure sensors shown in FIG. 13;

FIG. 15 is a flow chart illustrating an operation of the stone cleaner shown in FIG. 13;

FIGS. 16 to 18 are views illustrating a stone cleaner according to some example embodiments of the present disclosure; and

FIG. 19 is a schematic view illustrating an exposure device in which a stone cleaner according to some example embodiments of the present disclosure may be adopted.

### DETAILED DESCRIPTION OF THE DISCLOSURE

Hereinafter, the embodiments of the present disclosure will be described in detail with reference to the accompanying drawings. The same reference numerals will be used for the same elements on the drawings, and a repeated description of the corresponding elements will be omitted.

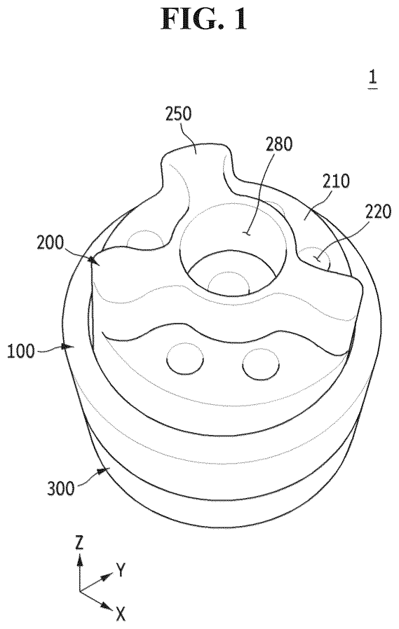

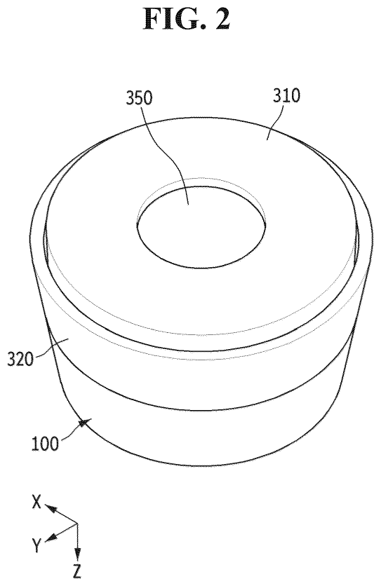

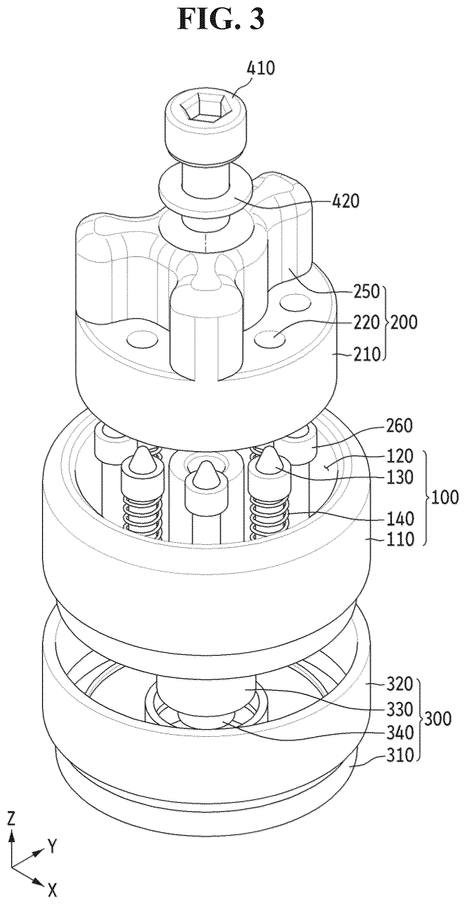

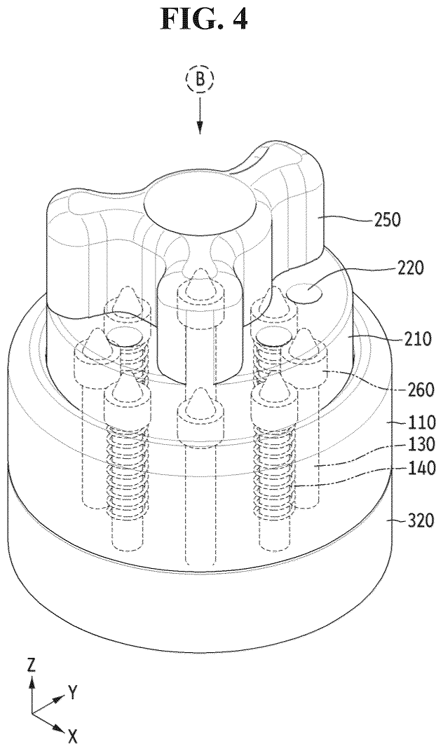

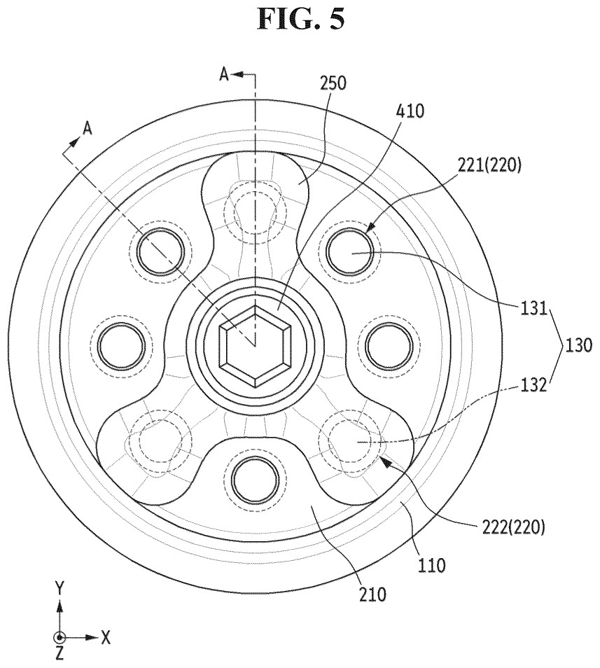

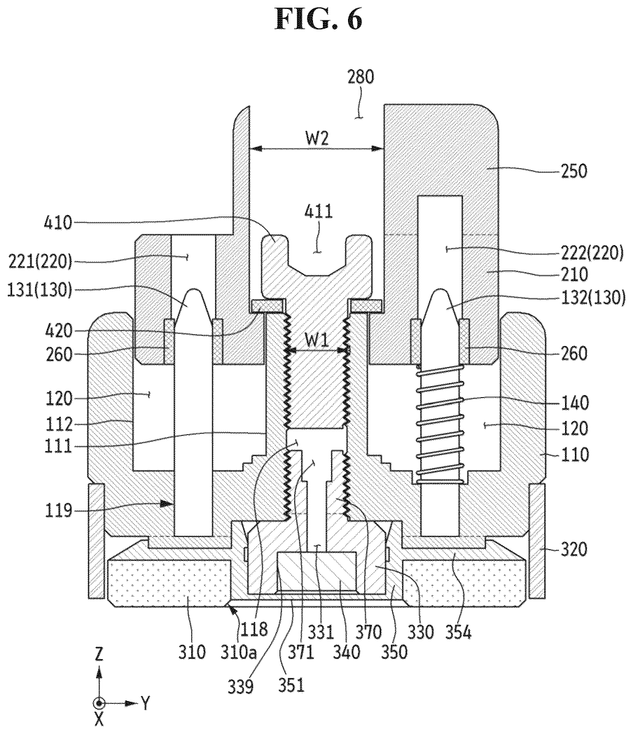

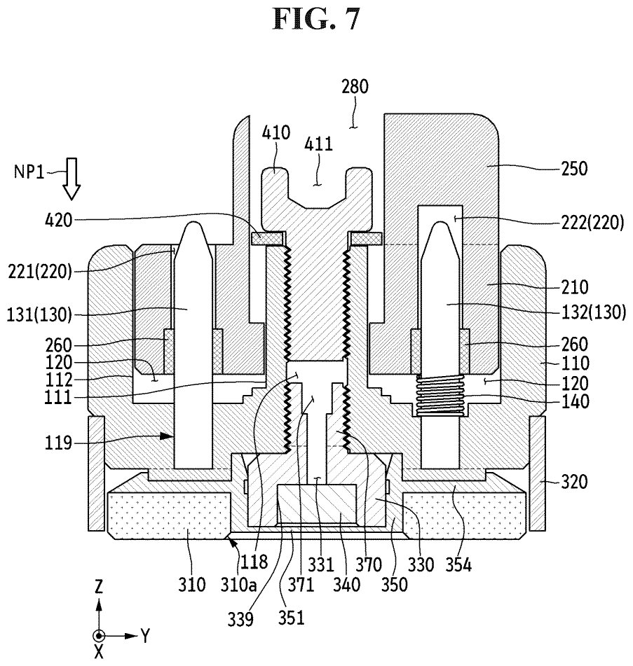

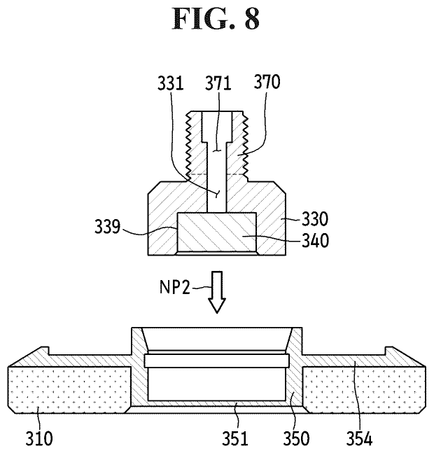

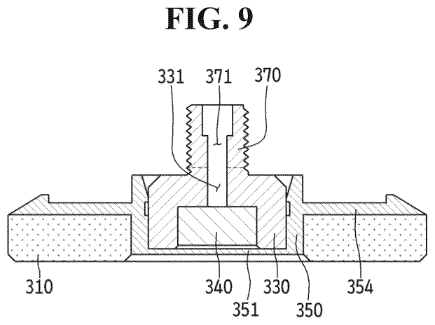

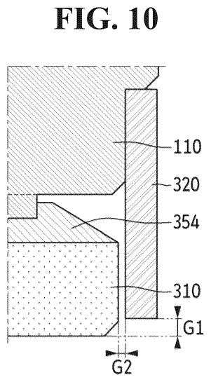

FIG. 1 is a perspective view illustrating a stone cleaner according to some example embodiments of the present disclosure. FIG. 2 is a perspective view illustrating a stone cleaner of FIG. 1, which is viewed from below. FIG. 3 is an exploded perspective view illustrating a stone cleaner of FIG. 1. FIG. 4 is a perspective view illustrating arrangement of a guide pin and an elastic body in the stone cleaner of FIG. 1. FIG. 5 is a view illustrating that the stone cleaner of FIG. 4 is viewed from B. FIG. 6 is a cross-sectional view taken along line A-A of FIG. 5. FIG. 7 is a view illustrating an operation of a stone cleaner of FIG. 1. FIGS. 8 and 9 are views illustrating a cleaning unit of the stone cleaner of FIG. 1. FIG. 10 is a view illustrating a ring guard of the stone cleaner of FIG. 1.

First, referring to FIGS. 1 to 6, the stone cleaner according to some embodiments of the present disclosure includes a main body 100, a handle 200, and a cleaning unit 300.

The main body 100 guides an operation of the handle 200. For example, the main body 100 guides vertical movement of the handle 200 and prevents the handle 200 from being detached. Further, the cleaning unit 300 for cleaning a wafer table is installed in the main body 100. The main body 100 may be made of plastic (for example, PolyEtherEtherKetone (PEEK), but is not limited thereto.

The main body 100 includes a body 110, a guide recess 120, a guide pin 130, and an elastic body 140.

The guide recess 120 is formed on an upper surface of the main body 100. The guide recess 120 may be defined by an inner wall 111 and an outer wall 112. For example, the inner wall 111 may have a cylindrical shape, and the outer wall 112 may also have a cylindrical shape, whereby the guide recess 120 may have a torus shape.

As will be described later, a first central hole 118 is installed inside the inner wall 111, and a screw 410 and a washer 420 are coupled to the first central hole 118. Accordingly, a depth of the guide recess 120 limits a maximum movable distance of the handle 200. The handle 200 moves within the guide recess 120 without being deviated from the guide recess 120. In other words, a height of the inner wall 111 may limit the maximum movable distance of the handle 200.

A plurality of grooves 119 are formed on a bottom surface of the guide recess 120. The plurality of grooves 119 may be, for example, eight, but embodiments are not limited thereto. The plurality of grooves 119 may be disposed at constant intervals, but embodiments are not limited thereto.

A plurality of guide pins 130 are installed in the guide recess 120. In detail, each of the plurality of guide pins 130 is installed/fixed in a corresponding groove 119. Accordingly, the plurality of guide pins 130 may be, for example, eight, and may be disposed at constant intervals.

The elastic body 140 is installed in at least one of the plurality of guide pins 130. For example, as shown in FIG. 4, the elastic body 140 may be installed only in four of the eight guide pins 130. The elastic body 140 may be installed on all of the eight guide pins 130. The number of installations (e.g., the number of guide pins 130 in which the elastic body 140 is installed), installation positions (e.g., the locations of the guide pins 130 in which the elastic body 140 is installed), and the like of the elastic body 140 may vary depending on a designed repulsive force.

Also, the plurality of guide pins 130 may be more protruded upward than the inner wall 111. For example, upper portions of the plurality of guide pins 130 may extend higher than the inner wall 111. In this configuration, when the handle 200 is pressed to the maximum (e.g., a maximum in the −Z direction), a first guide pin 131 may be exposed to the outside by passing through a corresponding first guide hole 221.

The plurality of guide pins 130 include a first guide pin 131 and a second guide pin 132. At least one first guide pin 131 having no elastic body 140 is provided, and at least one second guide pin 132 having the elastic body 140 is provided.

As will be described later, the elastic body 140 adjusts a pressing force of the handle 200. The elastic body 140 transfers the pressing force of the handle 200 to the cleaning unit 300 so that the cleaning unit 300 (i.e., the cleaning stone) may perform cleaning with a constant force.

The elastic body 140 may be a coil spring, but is not limited thereto. A spring constant, maximum compression, and free length are determined depending on a material, thickness, and the number of windings of the coil spring. The material, thickness, and the number of windings of the coil spring may be determined depending on the designed repulsive force, a length of the guide pin 130, a length of the guide hole 220, and the like.

The elastic body 140 may make an elastic force by at least one of a mechanical method, an electrical method, or a chemical method. For example, the elastic body 140 may include a sponge, rubber, a solenoid, etc., but embodiments are not limited thereto.

The handle 200 may move in a vertical direction (e.g., a Z direction) along the guide recess 120 of the main body 100. The handle 200 is provided with a body 210, a plurality of guide holes 220, an oil-less bush 260, a knob 250, and the like.

The plurality of guide holes 220 are installed in the body 210. The plurality of guide holes 220 correspond to the plurality of guide pins 130, and the corresponding guide pins 130 may move up and down in accordance with an extension direction of the guide hole 220. For example, each of the guide pins 130 may move up and down in a corresponding one of the plurality of guide holes 220. The plurality of guide holes 220 may be, for example, eight, but embodiments are not limited thereto. The plurality of guide holes 220 may be disposed at constant intervals, but embodiments are not limited thereto.

The oil-less bush 260 may be installed in each of the plurality of guide holes 220. For example, each of the plurality of guide holes 220 may include an oil-less bush 260. The oil-less bush 260 allows the guide pin 130 to smoothly move up and down along the guide hole 220. For cleanliness of a clean room, the oil-less bush 260 may have a hollow cylindrical shape made of a polymer material.

On the handle 200, a knob 250 for a worker to grasp with a finger is installed. In FIGS. 1 and 4, the knob 250 divided into three is shown, but is not limited thereto. The knob 250 may have a straight shape or a cross shape.

Meanwhile, the plurality of guide holes 220 may include a first guide hole 221 and a second guide hole 222. At least one first guide hole 221 is provided, and does not overlap the knob 250 and passes through the handle 200. At least one second guide hole 222 is provided, and overlaps the knob 250 and does not pass through the handle 200.

Although FIG. 6 shows that the first guide pin 131 in which the elastic body is not installed moves up and down along the first guide hole 221 and the second guide pin 132 in which the elastic body 140 is installed moves up and down along the second guide hole 222, the present disclosure is not limited thereto. For example, the second guide pin 132 in which the elastic body 140 is installed may move up and down along the first guide hole 221, or the first guide pin 131 in which the elastic body is not installed may move up and down along the second guide hole 222.

Meanwhile, the main body 100 includes a first central hole 118 having a first inner diameter W1.

The handle 200 includes a second central hole 280 having a second inner diameter W2. The second inner diameter W2 is greater than the first inner diameter W1.

A screw 410 and a washer 420 may be used to fix the main body 100 and the handle 200 to each other. The screw 410 is fastened to the first central hole 118 with a washer 420 interposed therebetween by passing through the first central hole 118 and the second central hole 280. For example, a thread of the screw 410 is coupled to a first inner thread installed on the inner wall of the first central hole 118. A groove 411 for fastening a wrench may be formed in a head of the screw 410. The screw 410 may be made of plastic (e.g., PEEK), but is not limited thereto. The washer 420 may be stainless steel (e.g., STS304), but is not limited thereto.

Also, the cleaning unit 300 is installed on a lower surface of the main handle 200. The cleaning unit 300 includes a chuck 330, a fastening unit 370, a cleaning stone 310, a holder 350, and a ring guard 320.

An installation groove 339 is formed below the chuck 330, and a magnet 340 is seated in the installation groove 339. The chuck 330 may be made of plastic (e.g., PEEK), but is not limited thereto.

The fastening unit 370 has a shape protruded from an upper portion of the chuck 330. The fastening unit 370 is used to fix the cleaning unit 300 and the main body 100 to each other. Since the fastening unit 370 has a thread, it may be coupled to a second inner thread installed on the inner wall of the first central hole 118 of the main body 100.

A groove 371 for fastening a wrench may be formed in the fastening unit 370. Also, a hole 331 connecting the groove 371 with the installation groove 339 may be formed.

The magnet 340 is fixed in the installation groove 339 through an adhesive, and when an excess adhesive remains in the installation groove 339, the flatness of the magnet 340 may be inhibited. As the excess adhesive is removed through the hole 331, the flatness of the magnet 340 may be stably maintained.

The holder 350 may include a cylindrical body having an open upper surface and an extension portion 354 elongated outward from the body. The cleaning stone 310 is fixed by the body of the holder 350 and the extension portion 354.

The cleaning stone 310 may have a flat doughnut shape, but is not limited thereto. An edge of the cleaning stone 310 has a round shape, and the cleaning stone 310 has a stable shape in which stress is not concentrated on a specific portion.

The cleaning stone 310 is used to remove contaminants deposited on the wafer table in a physical manner. The hardness of the cleaning stone 310 should be higher than that of the contaminants and lower than that of the wafer table. Thus, damage to the wafer table may be minimized so that the wafer table may be reused.

Also, when surface roughness of the cleaning stone 310 is too low, the amount of polishing is small, and thus precise polishing is possible, but the working time is increased. When surface roughness of the cleaning stone 310 is too high, there is a concern that the wafer table may be easily damaged. The cleaning stone 310 should be made of a material that may optimize polishing cleaning in consideration of a polishing power and work efficiency.

In consideration of hardness and surface roughness, the cleaning stone 310 may be alumina. Alumina is excellent in processability and economy. That is, alumina is relatively easy to process and manufacture, and thus it is easy to implement a desired shape and dimension. In addition, alumina is inexpensive and is easy to make into a desired purity and crystal size. The flatness of the cleaning stone 310 may be changed due to friction and abrasion with the wafer table and deposits, and alumina may be reused because it is easy to refurbish.

The holder 350 may be entirely made of metal, or a bottom surface 351 of the holder 350 may be made of metal. Due to such a configuration, the magnet 340 pulls the bottom surface 351 of the holder 350 such that the chuck 330 and the holder 350 are fixed to each other.

As shown, the bottom surface 351 of the holder 350 may be positioned to be higher than a bottom surface of the cleaning stone 310. Accordingly, an inner surface 310a of the cleaning stone 310 may be exposed by the holder 350. Due to such a configuration, only the cleaning stone 310 may be in contact with the wafer table when the stone cleaner 1 performs a cleaning operation.

Meanwhile, the ring guard 320 is installed along the outer wall of the main body 100. The ring guard 320 may be bonded to the main body 100. As shown in FIG. 10, a lower end surface of the ring guard 320 may be higher than the bottom surface of the cleaning stone 310 by a predetermined distance G1. For example, the distance G1 may be managed to be greater than or equal to 0.2 mm and less than or equal to 1 mm. For example, the distance G1 may be managed to be 0.6 mm. Due to such a configuration, only the cleaning stone 310 may be in contact with the wafer table when the stone cleaner 1 performs the cleaning operation.

The ring guard 320 serves to buffer the cleaning stone 310 so that the cleaning stone 310 may not be directly in contact with a bubble extraction seal (BES) of the wafer table. The ring guard 320 may be made of a soft Teflon, but is not limited thereto.

The cleaning stone 310 is not in contact with the ring guard 320. As shown, the cleaning stone 310 and the ring guard 320 may be spaced apart from each other by a predetermined distance G2.

In this case, the operation of the stone cleaner according to some embodiments of the present disclosure will be described with reference to FIGS. 6 and 7.

Referring to FIG. 6, when a worker is not using a stone cleaner, no pressure is applied to the handle 200 in a vertical direction (e.g., a Z direction). When no pressure is applied to the handle 200 in the vertical direction (e.g., the Z direction), the handle 200 is farthest from the bottom surface of the guide recess 120 by the repulsive force of the elastic body 140.

Referring to FIG. 7, the worker places the stone cleaner on the wafer table, and cleans the wafer table while rotating the stone cleaner by pushing the handle 200 (see reference numeral NP1) after holding the handle 200.

When the worker presses the handle 200, the second guide pin 132 is inserted along the extension direction of the second guide hole 222, and the elastic body 140 is compressed, so that the repulsive force of the elastic body 140 adjusts the pressing force of the handle 200. The pressing force of the handle 200 is entirely dispersed by the elastic body 140 so that the cleaning stone 310 may be entirely pressed. For example, as the elastic body 140 buffers an initial force for pressing the wafer table, damage to a burl of the wafer table may be prevented. Accordingly, a replacement period of the wafer table may be increased. For example, a period between replacements of the wafer table may be increased.

Also, the handle 200 moves downward in accordance with the force pressed by the worker. As the force pressed by the worker is increased, a distance by which the handle 200 moves downward is increased.

When the worker applies a force greater than the required force, the guide pin 131 passes through the first guide hole 221, and thus its tip is exposed to the outside of the handle 200. That is, the tip of the guide pin 131 touches the worker's hand. The worker finds that too strong force is being applied, and works by reducing the force. Therefore, the worker may prevent the wafer table or the stone cleaner from being damaged by working with too strong force. In addition, it is possible to minimize the change in cleaning power (i.e., deviation in cleaning power between workers) as the stone cleaner is used with a different force for each worker.

Meanwhile, referring to FIGS. 8 and 9, the holder 350 is fixed to the cleaning stone 310. An upper surface of the cleaning stone 310 may be in contact with the extension portion 354, and an inner side of the cleaning stone 310 may be in contact with an outer side of a body of the holder 350. The cleaning stone 310 may be fixed to the holder 350 by using an adhesive or the like.

The magnet 340 is fixed in the installation groove 339 of the chuck 330. The chuck 330 is pushed into a groove of the holder 350 (see reference numeral NP2). The magnet 340 is coupled to the bottom surface 351 of the holder 350 by a magnetic force.

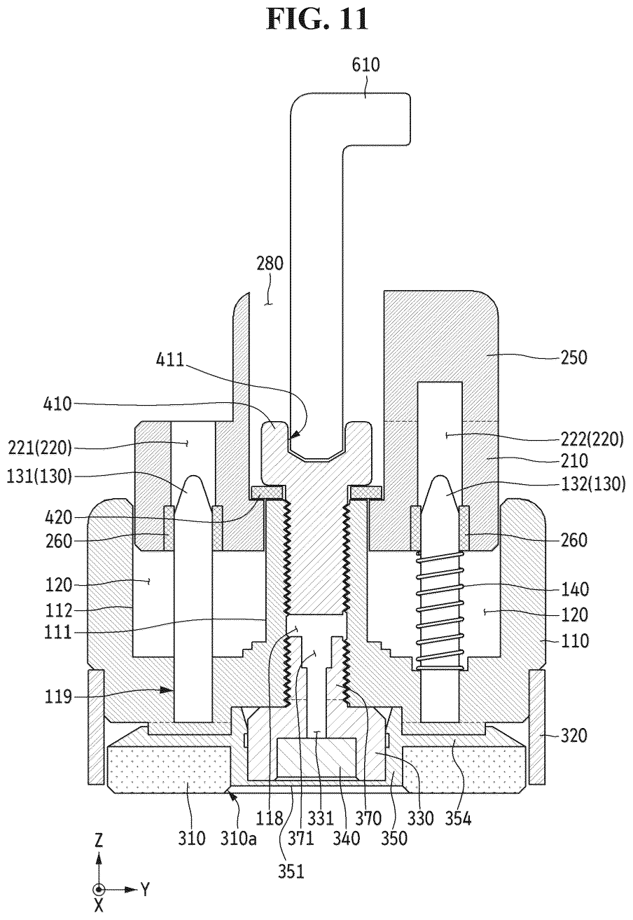

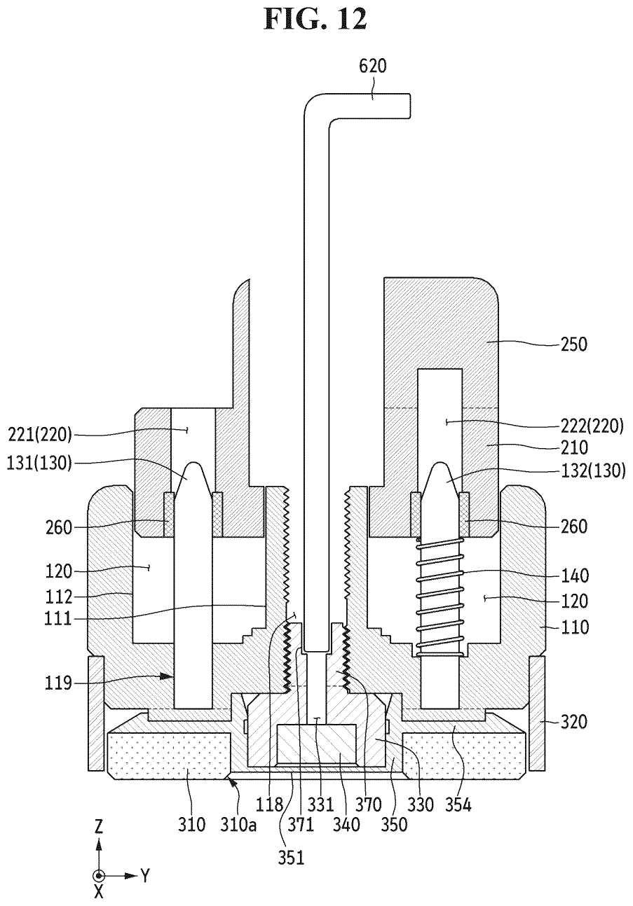

FIGS. 11 and 12 are views illustrating a method for disassembling a stone cleaner according to some embodiments of the present disclosure. When the maintenance of the stone cleaner is required due to severe abrasion of the cleaning stone, it is necessary to disassemble the stone cleaner.

As shown in FIG. 11, a wrench 610 is fastened to the groove 411 of the screw 410 by passing through the second central hole 280. The worker rotates the wrench 610 to separate the screw 410 from the main body 100.

Subsequently, as shown in FIG. 12, the wrench 620 is fastened to the groove 371 of the fastening unit 370 of the cleaning unit 300 by passing through the second central hole 280 and the first central hole 118. The worker rotates the wrench 620 to separate the cleaning unit 300 from the main body 100.

Subsequently, referring back to FIG. 9, since the magnet 340 of the chuck 330 and the bottom surface of the holder 350 are fixed by a magnetic force, the worker may disassemble the chuck 330 and the holder 350 by applying a force. The worn cleaning stone 310 may be separated from the holder 350 and then replaced with a new cleaning stone 310. Alternatively, the holder 350 may be replaced with a new holder 350 to which the new cleaning stone 310 is coupled.

Since only some components (the holder 350 and/or the cleaning stone 310) are replaced without replacing the entire stone cleaner, the stone cleaner according to some embodiments of the present disclosure may be used at a relatively low maintenance cost.

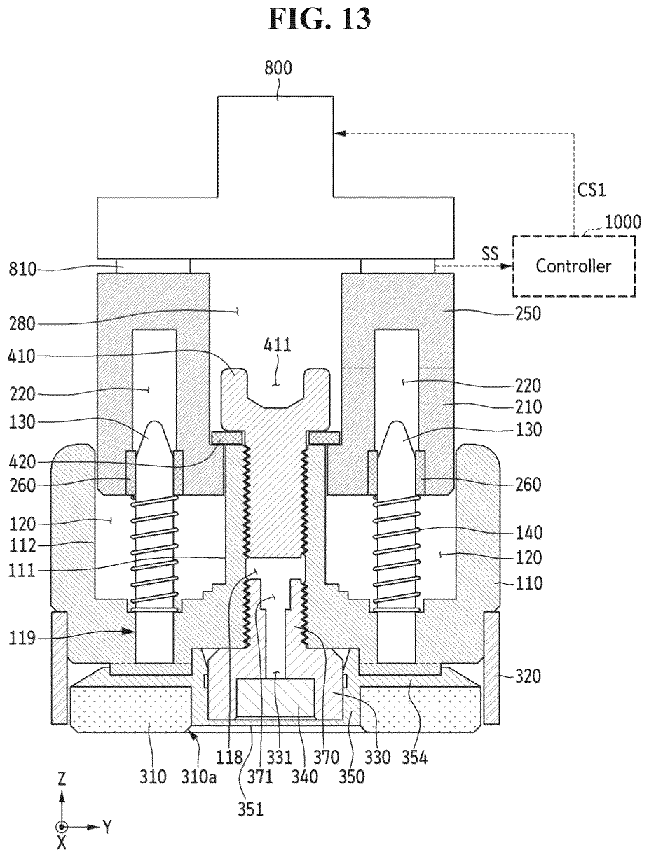

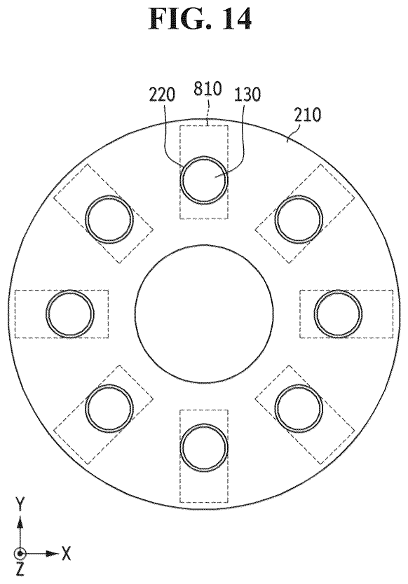

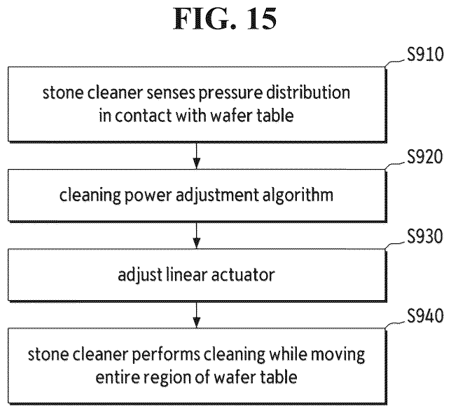

FIG. 13 is a view illustrating a stone cleaner according to some example embodiments of the present disclosure. FIG. 14 is a plan view illustrating a plurality of pressure sensors shown in FIG. 13. FIG. 15 is a flow chart illustrating an operation of the stone cleaner shown in FIG. 13. For convenience of description, the following description will be based on differences from those described with reference to FIGS. 1 to 12.

The stone cleaner described with reference to FIGS. 1 to 12 cleans the wafer table while the worker directly rotates the stone cleaner, whereas the operation of the stone cleaner shown in FIG. 13 may be controlled by a pusher 800, and may be installed in a semiconductor manufacturing device (e.g., an exposure device).

In detail, a plurality of pressure sensors 810 are installed on an upper surface of the handle 200. The pusher 800 is installed on the handle 200 to rotate the handle 200 while pressing the handle 200. Sensing values SS measured by the plurality of pressure sensors 180 are provided to a controller 1000. The controller 1000 checks a pressure applied to the handle 200 based on the measured sensing value SS and thus provides a signal CS1 for controlling the handle 200 to the handle 200.

Although not illustrated, the controller 1000 can include one or more of the following components: at least one central processing unit (CPU) configured to execute computer program instructions to perform various processes and methods, random access memory (RAM) and read only memory (ROM) configured to access and store data and information and computer program instructions, input/output (I/O) devices configured to provide input and/or output to the controller 1000 (e.g., keyboard, mouse, display, speakers, printers, modems, network cards, etc.), and storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium) where data and/or instructions can be stored. In addition, the controller 1000 can include antennas, network interfaces that provide wireless and/or wire line digital and/or analog interface to one or more networks over one or more network connections (not shown), a power source that provides an appropriate alternating current (AC) or direct current (DC) to power one or more components of the controller 1000, and a bus that allows communication among the various disclosed components of the controller 1000.

As shown in FIG. 14, the pressure sensor 810 may be disposed to overlap the guide hole 220/the guide pin 130. When the guide hole 220 and the guide pin 130 are disposed at a constant interval, the pressure sensor 810 may be also disposed at a constant interval. FIG. 14 shows that the pressure sensor 810 corresponds to the guide hole 220/guide pin 130 in one-to-one correspondence, but the present disclosure is not limited thereto. For example, the pressure sensor 810 may correspond to the guide hole 220/guide pin 130 in one-to-many correspondence. For example, in FIG. 14, four pressure sensors 810 may be installed for eight guide holes 220/guide pins 130.

Each of the plurality of pressure sensors 810 senses a pressure at a corresponding position and provides a sensing value SS to the controller 1000. For example, when a sensing value SS (i.e., pressure) measured at a first position among a plurality of sensing values SS is greater than a reference, the pusher presses the first position with a smaller force. When a sensing value SS measured at a second position among the plurality of sensing values SS is less than the reference, the pusher presses the second position with a larger force.

Referring to FIG. 15, before a cleaning operation starts, zero points of the plurality of pressure sensors 810 are adjusted.

The stone cleaner senses a pressure distribution in contact with the wafer table (S910). The stone cleaner is connected to a linear actuator. The pressure is measured from the plurality of pressure sensors 810, and the measured sensing value is transferred to the controller 1000. The controller 1000 operates a cleaning power adjustment algorithm based on the measured sensing value (S920). The controller 1000 adjusts the linear actuator in accordance with the operation result, and the pusher 800 rotates the stone cleaner while pressing the stone cleaner (S930).

The stone cleaner cleans the wafer table while moving the entire area of the wafer table in accordance with the operation of the controller 1000 (S940).

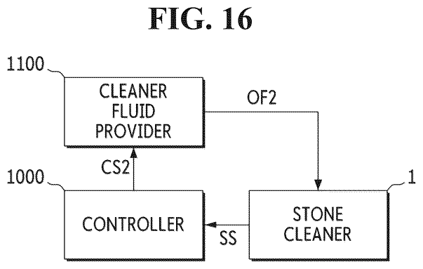

FIGS. 16 to 18 are views illustrating a stone cleaner according to some example embodiments of the present disclosure. For convenience of description, the following description will be based on differences from those described with reference to FIGS. 13 to 15.

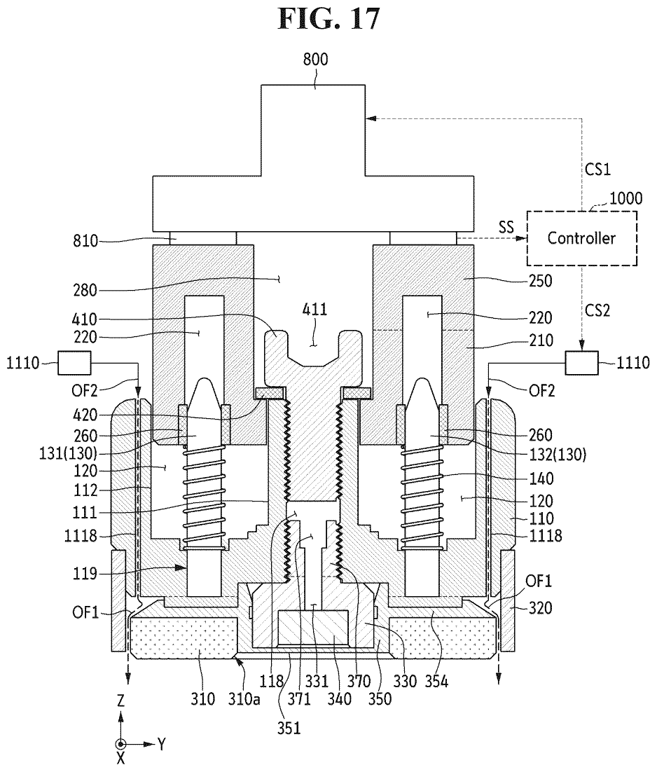

Referring to FIGS. 16 and 17, a plurality of cleaner fluid supply flow paths 1118 passing through the outer wall 112 are installed on the outer wall 112 of the main body 100. The plurality of cleaner fluid supply flow paths 1118 may extend entirely through the outer wall 112, and include an openings at an upper region of the outer wall 112 and openings at a lower region of the outer wall 112.

A cleaner fluid provider 1110 provides the cleaner fluid to the cleaner fluid supply flow paths 1118 (see OF2). The cleaner fluid moves downward along the cleaner fluid supply flow paths 1118, and is discharged into a space between the cleaning stone 310 and the ring guard 320 (see OF1). The cleaner fluid provider 1110 may be a supply unit or supply container storing cleaner fluid that is supplied to the cleaner fluid supply flow paths 1118.

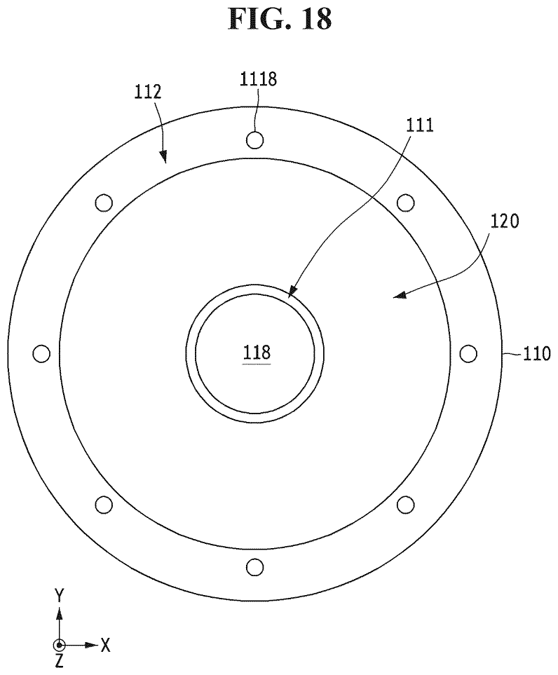

As shown in FIG. 18, the cleaner fluid supply flow paths 1118 may be disposed at constant intervals. For example, the cleaner fluid supply flow paths 1118 may be disposed to be adjacent to the position where the guide hole 220/guide pin 130 is installed. FIG. 18 shows eight cleaner fluid supply flow paths 1118 but the present disclosure is not limited thereto. For example, four or two cleaner fluid supply flow paths 1118 may be installed.

Referring back to FIG. 16 and FIG. 17, the controller 1000 controls the cleaner fluid provider 1110 (using a control signal CS2). The cleaner fluid provider 1110 may adjust the amount of cleaner fluid provided to the stone cleaner 1 (see reference numeral OF2). For example, based on the sensing value SS measured by the pressure sensor 810, the force pressed by the pusher 800 and the amount of the cleaner fluid supplied by the cleaner fluid provider 1110 may be adjusted.

In addition, the stone cleaner 1 to which the cleaner fluid is supplied may clean the wafer table in a space equipped with an exhaust system (e.g., an exhaust hood). The used cleaner fluid may be removed by the exhaust system (e.g., the exhaust hood).

The cleaner fluid used to clean the wafer table may be evaporated to affect optics of the exposure device. Therefore, when the wafer table is cleaned using the cleaner fluid, it is necessary to perform the cleaning in a zone where the exhaust system (exhaust hood) is installed. The exhaust system (exhaust hood) may protect optics of the exposure device by removing the evaporated cleaner fluid.

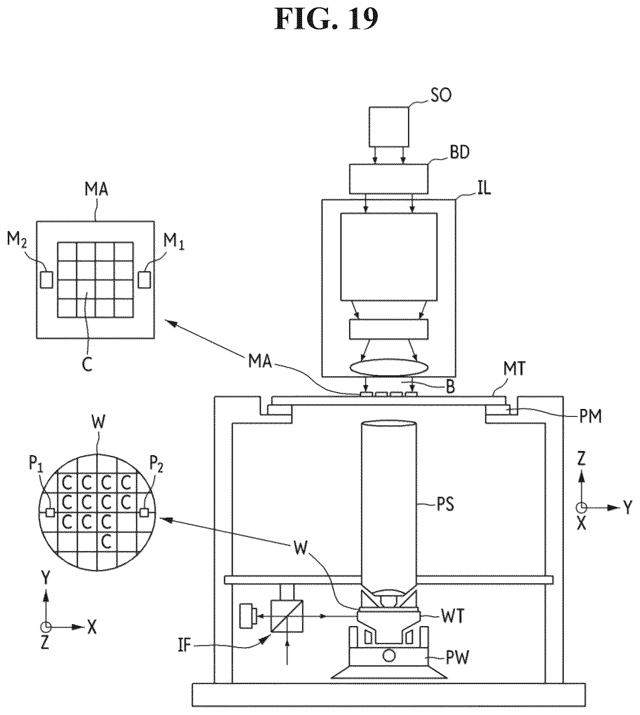

FIG. 19 is a schematic view illustrating an exposure device in which a stone cleaner according to some example embodiments of the present disclosure may be adopted.

Referring to FIG. 19, the exposure device includes an illuminator IL, a mask table MT, a wafer table WT, and a projection system PS.

The illuminator IL is configured to adjust a radiation beam B (e.g., UV radiation or DUV radiation).

A support structure (e.g., mask table MT) is configured to support a patterning device (e.g., mask MA), and is connected to a first positioner PM configured to accurately position the patterning device MA depending on a specific parameter.

A sensor table or wafer table WT is configured to maintain a substrate (e.g., resist-coated wafer W), and is connected to a second positioner PW configured to accurately position a surface of the table, such as the substrate W, depending on the specific parameter.

The projection system PS (e.g., refractive projection lens system) is configured to project a pattern given to the radiation beam B by the patterning device MA onto a target portion C of the substrate W.

In detail, when operated, the illuminator IL receives a radiation beam or radiation from a source SO, for example through a beam delivery system BD. The illuminator IL may include various types of optical elements such as refractive, reflective, magnetic, electromagnetic, capacitive and/or any other type of optical components or any combination thereof to direct, mold and/or control the radiation. The illuminator IL may be used to adjust the radiation beam B so that the radiation beam has a desired spatial and angular intensity distribution on its cross-section on a plane of the patterning device MA.

The term “projection system” used herein should be broadly interpreted as including various types of projection systems that include refractive, reflective, reflective-refractive, anamorphic, magnetic, electromagnetic and/or electrostatic optical system, or any combination thereof, which is suitable for the used exposure radiation and/or the use of immersion liquids and other factors.

The exposure device may be of a type having two or more support tables, for example, two or more support tables or a combination of one or more support tables and one or more cleaning, sensor or measurement tables. For example, the exposure device is a multi-stage device that includes two or more tables positioned on an exposure side of the projection system, wherein each of the tables includes and/or maintains one or more target objects. In an example, one or more of the tables may maintain a radiation sensitive substrate. In an example, one or more of the tables may maintain a sensor to measure the radiation from the projection system. In an example, the multi-stage device includes a first table (i.e., a support table) configured to maintain a radiation-sensitive substrate and a second table (hereinafter, referred to, generally or but not limited to, as a measurement, sensor and/or cleaning table) configured to maintain a radiation-sensitive substrate. The second table may include and/or maintain one or more target objects other than the radiation-sensitive substrate. One or more of these target objects may include a sensor for measuring radiation from the projection system, one or more alignment marks, and/or one or more selected from a cleaning device (e.g., for cleaning a liquid-limited structure).

When operated, the radiation beam B is incident on the patterning device MA maintained on the support structure MT, and is patterned by a pattern (design layout) present in the patterning device MA. The radiation beam B across the patterning device MA passes through the projection system PS, which focuses the beam onto the target portion C of the substrate W. With the help of the second positioner PW and a position sensor IF (e.g., an interferometer device, a linear encoder, a 2-D encoder, or a capacitive sensor), for example, in order to focus different target portions C in the path of the radiation beam B and position them in an aligned position, the wafer table WT may move accurately. Similarly, the first positioner PM and another position sensor may be used to accurately position the patterning device MA with respect to the path of the radiation beam B. The patterning device MA and the substrate W may be aligned using patterning device alignment marks M1 and M2 and substrate alignment marks P1 and P2. As shown, the substrate alignment marks MI and M2 occupy a dedicated target portion, but they may be positioned in the space between the target portions C.

The stone cleaner described with reference to FIGS. 1 to 18 may be used to clean the wafer table WT of FIG. 19. A plurality of burls may be formed on the surface of the wafer table WT. The worker may manually clean the wafer table WT by using the stone cleaner. Alternatively, the stone cleaner is installed in the exposure device, so that a controller of the exposure device may control the stone cleaner to automatically clean the wafer table WT.

Although the embodiments of the present disclosure have been described with reference to the accompanying drawings, it will be apparent to those skilled in the art that the present disclosure can be fabricated in various forms without being limited to the above-described embodiments and can be embodied in other specific forms without departing from technical spirits and essential characteristics of the present disclosure. Thus, the above embodiments are to be considered in all respects as illustrative and not restrictive.

What is claimed is:

1. A stone cleaner comprising:
a main body including a guide recess;
a handle configured to move up and down along the guide recess; and
a cleaning unit installed on a lower surface of the main body, and including a cleaning stone,
wherein a plurality of guide pins are installed in the guide recess of the main body, and an elastic body is installed in at least one of the plurality of guide pins,
wherein a plurality of guide holes corresponding to the plurality of guide pins are installed in the handle,
wherein when the handle is pressed downward, each of the guide pins is inserted along an extension direction of a corresponding one of the guide holes, and the elastic body is compressed so that a repulsive force of the elastic body adjusts a pressing force of the handle.

2. The stone cleaner of claim 1,
wherein a first guide hole of the plurality of guide holes passes through the handle, and a first guide pin of the plurality of guide pins corresponds to the first guide hole,
wherein when the handle is pressed downward by a predetermined depth or more, the first guide pin completely passes through the first guide hole so that a tip of the first guide pin is exposed to the outside of the handle.

3. The stone cleaner of claim 2,
wherein the handle further includes a knob for a worker to grasp with a finger, and
wherein a second guide hole of the plurality of guide holes is formed to overlap the knob.

4. The stone cleaner of claim 1,
wherein the main body includes an outer wall and an inner wall, which define the guide recess, and
wherein the guide pins are more protruded upward than the inner wall.

5. The stone cleaner of claim 1, further comprising:
a first central hole passing through the main body and having a first inner diameter;
a second central hole passing through the handle and having a second inner diameter; and
a screw passing through the first central hole and the second central hole,
wherein a thread of the screw is coupled to a first inner thread installed on an inner wall of the first central hole.

6. The stone cleaner of claim 1,
wherein the cleaning unit includes:
a chuck;
an installation groove formed below the chuck;
a magnet seated in the installation groove; and
a holder holding the chuck and the magnet, and
wherein a bottom surface of the holder is made of metal, and the magnet and the bottom surface of the holder are fixed by a magnetic force.

7. The stone cleaner of claim 6,
wherein the main body further includes a first central hole having a first inner diameter,
wherein the cleaning unit further includes a fastening unit installed to be protruded from an upper portion of the chuck, and
wherein a thread of the fastening unit is configured to be coupled to a second inner thread installed on an inner wall of the first central hole.

8. The stone cleaner of claim 1,
wherein the main body includes an outer wall and an inner wall, which define the guide recess, and is provided with a cleaner fluid supply flow path passing through the outer wall,
wherein a ring guard is installed along an outer sidewall of the main body, and
wherein a cleaner fluid is supplied through the cleaner fluid supply flow path, and is provided to a space between the ring guard and the cleaning stone.

9. The stone cleaner of claim 1,
wherein a plurality of pressure sensors are installed on an upper surface of the handle, and overlap the plurality of guide holes, and
wherein the stone cleaner further comprising a pusher for adjusting a pressure applied to the handle in accordance with a sensing value measured from the plurality of pressure sensors.

10. The stone cleaner of claim 1, wherein the elastic body includes a coil spring.

11. The stone cleaner of claim 1, wherein each of the plurality of guide holes is provided with an oil-less bush.

12. The stone cleaner of claim 1, further comprising a ring guard installed along an outer sidewall of the main body.

13. The stone cleaner of claim 12, wherein a lower end surface of the ring guard is higher than a bottom surface of the cleaning stone.

14. A stone cleaner comprising:
a main body including a guide recess;
a handle configured to move up and down along the guide recess, including a knob for a worker to grasp with a finger; and
a cleaning unit installed on a lower surface of the main body, and including a cleaning stone,
wherein the main body includes an outer wall and an inner wall, which define the guide recess,
wherein a plurality of guide pins are installed in the guide recess of the main body, the plurality of guide pins are more protruded upward than the inner wall, and a coil spring is installed in at least one of the plurality of guide pins,
wherein a plurality of guide holes corresponding to the plurality of guide pins are installed in the handle,
wherein the plurality of guide holes include a first guide hole and a second guide hole, the first guide hole passes through the handle without overlapping the knob, the second guide hole overlaps the knob, and the plurality of guide pins include a first guide pin corresponding to the first guide hole and a second guide pin corresponding to the second guide hole, and
wherein when the handle is pressed downward by a predetermined depth or more, the first guide pin completely passes through the first guide hole so that a tip of the first guide pin is exposed to the outside of the handle.

15. The stone cleaner of claim 14, further comprising:
a first central hole passing through the main body and having a first inner diameter;
a second central hole passing through the handle and having a second inner diameter; and
a screw passing through the first central hole and the second central hole,
wherein a thread of the screw is coupled to a first inner thread installed on an inner wall of the first central hole,
wherein the cleaning unit further includes a chuck and a fastening unit installed to be protruded from an upper portion of the chuck, and
wherein a thread of the fastening unit is configured to be coupled to a second inner thread installed on the inner wall of the first central hole.

16. The stone cleaner of claim 14, further comprising:
a ring guard installed along an outer sidewall of the main body,
wherein a lower end surface of the ring guard is higher than a lower end surface of the cleaning stone.

17. The stone cleaner of claim 16, wherein the ring guard is disposed to be spaced apart from the cleaning stone.

18. A semiconductor manufacturing device comprising:
a wafer table provided with a plurality of burls formed on a surface;
a stone cleaner configured to clean the wafer table; and
a controller configured to control the stone cleaner,
wherein the stone cleaner includes:
a main body including a guide recess;
a handle configured to move up and down along the guide recess; and
a cleaning unit installed on a lower surface of the main body, including a cleaning stone,
wherein a plurality of guide pins are installed in the guide recess of the main body, and an elastic body is installed in at least one of the plurality of guide pins,
wherein a plurality of guide holes corresponding to the plurality of guide pins are installed in the handle, and
wherein when the handle is pressed downward, the plurality of guide pins are inserted along an extension direction of the plurality of guide holes, respectively, and the elastic body is compressed so that a repulsive force of the elastic body adjusts a pressing force of the handle.

19. The semiconductor manufacturing device of claim 18,
wherein the stone cleaner further includes:
a plurality of pressure sensors installed on an upper surface of the handle and overlapped with the plurality of guide holes; and
a pusher configured to apply a pressure to the handle, and
wherein the controller adjusts the pressure applied to the handle in accordance with a sensing value measured from the plurality of pressure sensors.

20. The semiconductor manufacturing device of claim 18,
wherein the main body further includes a cleaner fluid supply flow path,
wherein a ring guard is installed along an outer sidewall of the main body, and
wherein a cleaner fluid is supplied through the cleaner fluid supply flow path, and is provided to a space between the ring guard and the cleaning stone.
